(19) United States
(12) Patent Application Publication
(10) Pub. No.: US 2005/0104809 A1
(43) Pub. Date: May 19, 2005

(54) Panel driving method for sustain period and display panel using the same

(75) Inventors: Woo-Joon Chung, Asan-si (KR); Kyoung-Ho Kang, Suwon-si (KR); Seung-Hun Chae, Suwon-si (KR); Jin-Sung Kim, Cheonan-si (KR)

Correspondence Address: MCGUIREWOODS, LLP, 1750 TYSONS BLVD, SUITE 1800, MCLEAN, VA, 22102, US

(73) Assignee: Samsung SDI Co., Ltd.

(21) Appl. No.: 10/958,647

(22) Filed: Oct. 6, 2004

(30) Foreign Application Priority Data
Oct. 8, 2003 (KR) 2003-0070046

(51) Int. Cl. G09G 3/28

(52) U.S. Cl. 345/60

(57) ABSTRACT

A method for driving a display panel to produce an efficient sustain discharge is provided. In one embodiment, the display panel includes a plurality of scanning electrodes that are driven by a sustain discharge signal. A corresponding plurality of common electrode groups is driven individually by different sustain discharge signals. Sustain discharge is performed by alternately applying high level sustain pulses to each the plurality of scanning electrodes and each the plurality of common electrode groups. Sustain pulses with a high level are applied sequentially to each the plurality of common electrode groups in time intervals between the sustain pulses with the high level applied to the plurality of scanning electrodes. Therefore, it is possible to maintain a duty rate of a sustain discharge signal near 50% while reducing a peak value of currents generated upon sustain discharge driving, thereby achieving stable sustain discharge.

### BACKGROUND OF THE INVENTION

This application claims priority to Korean Patent Application No. 2003-70046, filed on Oct. 8, 2003, in the Korean Intellectual Property Office, the disclosure of which is herein incorporated by reference in its entirety.

1. Field of the Invention

The present invention relates to a method for driving a display panel to display an image by applying a sustain pulse to an electrode structure, such as a PDP (Plasma Display Panel), which forms a plurality of display cells.

2. Description of the Related Art

An electrode driving method of a PDP (Plasma display panel) is disclosed in U.S. Pat. No. 5,541,618. A panel driving timing may be divided into a reset (initialization) period, an address (write) period, and a sustain (display) period. In the reset period, a state of each of cell is initialized so that a subsequent addressing operation may be correctly performed. In the address period, cells to be turned-on on the display panel are selected and wall charges are accumulated in the selected cells. In the sustain period, discharge is performed in order to actually display an image on the selected (addressed) cells.

A conventional sustain discharge method is performed by alternately applying a sustain pulse to a scanning electrode and then to a common electrode. However, in the conventional method, since one sustain pulse is applied to a scanning electrode group and another sustain pulse is applied to a common electrode group, a peak value of currents sensed by a driving circuit is great.

### SUMMARY OF THE INVENTION

The present invention provides a display panel having an electrode structure that includes a predetermined arrangement of one or more scanning electrode groups and one or more common electrode groups. The invention further provides a method for efficiently driving the display panel.

The present invention discloses a method for driving a display panel to produce an efficient sustain discharge. The display panel may include a plurality of scanning electrodes and a plurality of common electrode groups paired with the plurality of scanning electrodes. The plurality of scanning electrodes may be driven by a sustain discharge signal. The plurality of common electrode groups may be driven individually by different sustain discharge signals. The method for driving the display panel may efficiently produce a sustain discharge by alternately applying high level sustain pulses to each of the plurality of scanning electrodes and each of the plurality of common electrode groups. Additionally, the method may sequentially apply high level sustain pulses to each of the plurality of common electrode groups in time intervals between the high level sustain pulses applied to the plurality of scanning electrodes.

In such a method, a period for sustain discharge may include changing a level of a first common electrode group to a high level when the plurality of scanning electrodes are in a high level; changing levels of the plurality of scanning electrodes to a low level when the first common electrode group is in the high level; changing levels of second through final common electrode groups sequentially to a high level when the plurality of scanning electrodes are in the low level; and changing levels of the plurality of scanning electrodes to a high level when the final common electrode group is in the high level.

According to another aspect of the present invention, there is provided a method for driving a display panel to produce an efficient sustain discharge. The panel may include a plurality of scanning electrode groups and a plurality of common electrode groups paired with the plurality of scanning electrode groups. The plurality of scanning electrode groups may be driven individually by different sustain discharge signals. The plurality of common electrode groups may be driven individually by different sustain discharge signals. The method may produce an efficient sustain discharge by alternately applying high level sustain pulses to each of the plurality of scanning electrode groups and each of the plurality of common electrode groups paired with the plurality of scanning electrode groups. The method may further sequentially apply high level ustain pulses to each of the plurality of common electrode groups paired with the plurality of scanning electrode groups in time intervals between the high level sustain pulses applied to each of the plurality of scanning electrode groups.

The method may apply high level sustain pulses in a predetermined time interval to each of the plurality of scanning electrode groups. In each of the plurality of scanning electrode groups, a period for sustain discharge may include changing a level of a first common electrode group belonging to a corresponding scanning electrode group to a high level when a pulse with a high level is applied to each of the plurality of scanning electrode groups; changing levels of the plurality of scanning electrode groups to a low level when the first common electrode group is in the high level; changing levels of second through final common electrode groups sequentially to a high level when the plurality of scanning electrode groups are in the low level; and changing levels of the plurality of scanning electrode groups to a high level when the final common electrode group is in the high level.

Also, a period for sustain discharge may include changing a level of a first common electrode group to a high level when a pulse with a high level is applied to all the plurality of scanning electrode groups; changing levels of first through final scanning electrode groups sequentially to a low level when the first common electrode group is in the high level; changing levels of second through final common electrode groups sequentially to a high level when the final scanning electrode group is in the low level; and changing levels of first through final scanning electrode groups sequentially to a high level when the final common electrode group is in the high level.

According to another aspect of the present invention, there is provided a method for driving a display panel to produce an efficient sustain discharge. The panel may include a plurality of common electrodes and a plurality of scanning electrode groups paired with the plurality of common electrodes, The plurality of common electrodes may be driven by a sustain discharge signal. The plurality of scanning electrode groups may be driven individually by different sustain discharge signals. Sustain discharge may be performed by alternately applying high level sustain pulses to each of the plurality of common electrodes and each of the plurality is of scanning electrode groups, and by sequentially applying high level sustain pulses to each of the plurality of scanning electrode groups in time intervals between the high level sustain pulses applied to the plurality of common electrodes.

In one embodiment, a period for sustain discharge may include: changing a level of a first scanning electrode group to a high level when the plurality of common electrodes are in a high level; changing levels of the plurality of common electrodes to a low level when the first scanning electrode group is in the high level; changing levels of second through final scanning electrode groups sequentially to a high level when the plurality of common electrodes are in the low level; and changing levels of the plurality of common electrodes to a high level when the final scanning electrode group is in the high level.

According to another aspect of the present invention, there is provided a method for driving a display panel to produce an efficient sustain discharge. The panel may include a plurality of common electrode groups and a plurality of scanning electrode groups paired with the plurality of common electrode groups. The plurality of common electrode groups may be driven individually by different sustain discharge signals. The plurality of scanning electrode groups may also be driven individually by different sustain discharge signals. The sustain discharge may be performed by alternately applying high level sustain pulses to the plurality of common electrode groups and the plurality of scanning electrode groups paired with the plurality of common electrode groups, and by sequentially applying high level sustain pulses to each of the plurality of scanning electrode groups paired with the plurality of common electrode groups, in time intervals between the high level sustain pulses applied to the plurality of common electrode groups.

In this embodiment, high level pulses may be applied in a predetermined time interval to each of the plurality of common electrode groups. In each of the plurality of common electrode groups, a period for sustain discharge may include: changing a level of a first scanning electrode group belonging to a corresponding common electrode group to a high level, when a pulse with a high level is applied to each of the plurality of common electrode groups; changing levels of the plurality of common electrode groups to a low level when the first scanning electrode group is in the high level; changing levels of second through final scanning electrode groups sequentially to a high level when the plurality of common electrode groups are in the low level; and changing a voltage applied to the plurality of common electrode groups to a high level when the final scanning electrode group is in the high level.

Also, a period for sustain discharge may include changing a level of a first scanning electrode group to a high level when all the plurality of common electrode groups are in a high level; changing levels of first through final common electrode groups sequentially to a low level when the first scanning electrode group is in the high level; changing levels of second through final scanning electrode groups sequentially to a high level when the final common electrode group is in the low level; and changing first through final common electrode groups sequentially to a high level when the final scanning electrode group is in the high level.

Another aspect of the present invention may provide a display panel with an electrode structure that includes a plurality of scanning electrodes driven by a sustain discharge signal; and a plurality of common electrode groups, which are paired with the plurality of scanning electrodes and driven individually by different sustain discharge signals.

Another aspect of the invention may provide a display panel having an electrode structure that includes a plurality of scanning electrode groups, which are driven individually by different sustain discharge signals; and a plurality of common electrode groups, which are paired with the plurality of scanning electrode groups and driven individually by different sustain discharge signals.

Yet another aspect of the invention may provide a display panel having an electrode structure that includes a plurality of common electrodes, which are driven by a sustain discharge signal; and a plurality of scanning electrode groups, which are paired with the plurality of common electrodes and driven individually by different sustain charge signals.

Yet another aspect of the present invention may provide a display panel having an electrode structure that includes a plurality of common electrode groups, which are driven individually by different sustain discharge signals; and a plurality of scanning electrode groups, which are paired with the plurality of common electrode groups and driven individually by different sustain discharge signals.

### BRIEF DESCRIPTION OF THE DRAWINGS

The above and other features and advantages of the present invention will become more apparent by describing in detail exemplary embodiments thereof with reference to the attached drawings.

FIG. 1 is a perspective view of an AC-type plasma display panel to which a method of the present invention may be applied.

FIG. 2 illustrates an electrode arrangement of a display panel to which the present invention may be applied.

FIG. 3 is a timing diagram for explaining an example of driving signals used in the display panel shown in FIG. 1.

FIG. 4a schematically shows an electrode structure for sustain discharge of the display panel, according to an embodiment of the present invention.

FIGS. 4b, 4c, and 4d are timing diagrams each showing a period of a sustain discharge signal applied to the electrode structure shown in FIG. 4a, according to embodiments of the present invention.

FIG. 5a schematically shows an electrode structure for sustain discharge of a display panel, according to another embodiment of the present invention.

FIG. 5b is a timing diagram of a sustain discharge signal applied to the electrode structure of FIG. 5a, according to an embodiment of the present invention.

FIGS. 6a and 6b schematically show electrode structures for sustain discharge of the display panel, according to another embodiment of the present invention.

FIG. 6c is a timing diagram of a sustain discharge signal applied to the electrode structures of FIGS. 6a and 6b, according to an embodiment of the present invention.

FIG. 7a schematically shows an electrode structure for sustain discharge, according to another embodiment of the present invention.

FIGS. 7b, 7c, and 7d are timing diagrams each showing a period of a sustain discharge signal applied to the electrode structure shown in FIG. 7a, according to embodiments of the present invention.

FIG. 8a schematically shows an electrode structure for sustain discharge of the display panel, according to another embodiment of the present invention.

FIG. 8b is a timing diagram of a sustain discharge signal applied to the electrode structure of FIG. 8a, according to an embodiment of the present invention.

### DETAILED DESCRIPTION OF THE INVENTION

Hereinafter, embodiments of the present invention will be described in detail with reference to the appended drawings. The present embodiments will be explained based on a method for driving an AC-type plasma display panel.

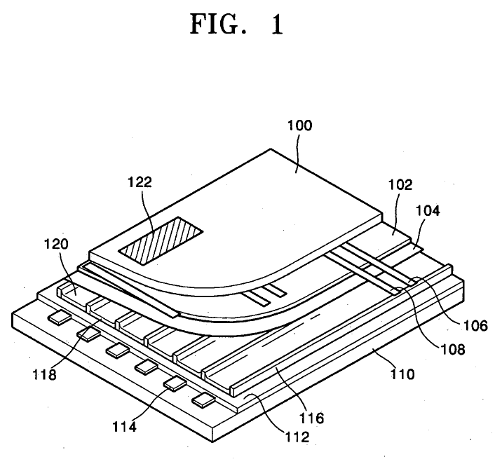

FIG. 1 is a perspective view of an AC-type plasma display panel to which the present invention may be applied. Pairs of a scanning electrode 106 and a sustain (common) electrode 108, which are covered with a dielectric layer 102 and a protection film 104, are arranged in parallel with each other on a first glass substrate 100. A plurality of address electrodes 114, which may be covered with an insulator layer 112, may be arranged on a second glass substrate 110. The address electrode 114 is arranged in a manner to intersect the scanning electrode 106 and common electrode 108. Partition walls 116 may be formed on the insulator layer 112 covering the address electrodes 114 in a manner to be parallel to the address electrodes 114. Also, phosphors 118 may be formed on the insulator layer 112 and between the partition walls 116. The first glass substrate 100 and the second glass substrate 110 may be opposite to each other, between which a discharge space 120 may be formed by a plurality of the scanning electrodes 106 and common electrodes 108, and the address electrodes 114 and the partition walls 116. A discharge cell 122 may be formed in an intersection of an address electrode 114 and a pair of a scanning electrode 106 and common electrode 108.

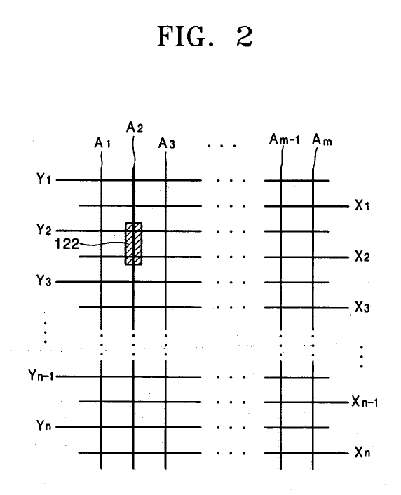

FIG. 2 illustrates an electrode arrangement of a display panel to which the present invention may be applied. Electrodes may be arranged with a matrix structure of m×n. Address electrodes A1 through Am may be arranged in the column direction of the matrix structure, and N scanning electrodes SCN1 through SCNn and N common electrodes SUS1 through SUSn may be arranged in the row direction thereof. A discharge cell formed in an intersection of an address electrode A2, a scanning electrode Y2, and a common electrode X2, shown in FIG. 2, corresponds to the discharge cell 122 shown in FIG. 1. A discharge cell to be displayed may be selected by an address electrode and a scanning electrode, and the selected discharge cell may be is forced to sustain discharge by the scanning electrode and a common electrode.

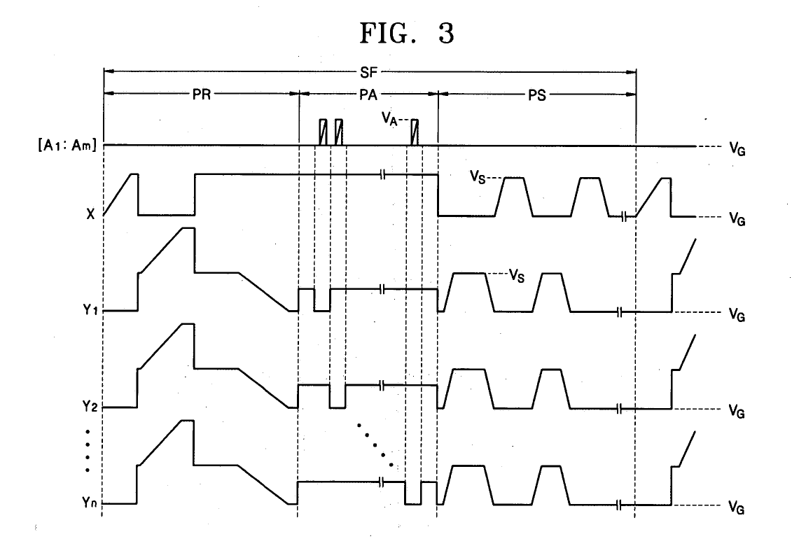

FIG. 3 is a timing diagram for explaining an example of driving signals used in the display panel shown in FIG. 1. FIG. 3 shows driving signals applied to an address electrode A, a common electrode X and scanning electrodes Y1 through Yn in a sub-field SF according to anAddress Display Separated (ADS) driving method used in an AC PDP. Referring to FIG. 3, a sub-field SF may includea reset period PR, an address period PA and a sustain discharge period PS.

In the reset period PR, a reset pulse may be applied to all groups of scanning lines, so that states of wall charges of cells are initialized. Since the reset period PR exists prior to the address period PA and cell initialization is performed throughout an entire screen during the reset period PR, wall charges in all display cells may be uniformly distributed after the reset period PR. Just after the reset period PR ends, the address period PA begins. In the address period PA, a bias voltage Vₑ may be applied to a common electrode X, and a display cell may be selected by simultaneously turning on scanning electrodes Y₁ through Yₙ and address electrodes A₁ through Aₘ at the location of a cell to be displayed. After the address period PA ends, a sustain pulse Vₛ may be alternately applied in the sustain discharge period PS to the common electrode X and to the scanning electrodes Y₁ through Yₙ. During the sustain discharge period PS, a voltage VG with a low level may be applied to the address electrodes A1 through Am.

FIG. 3 illustrates a driving signal in which a group of a reset period PR, an address period PR and a sustain discharge period PS exists in a sub-field SF. However, a single sub-field may be divided into a predetermined number of the groups. For example, it may be possible to divide the scanning electrodes Y1 through Yn into a predetermined number of groups and to apply a reset period PR, an address period PR, and a sustain discharge period PS to each of the groups. Also, for example, it may be possible to divide a plurality of common electrode X into a predetermined number of groups and apply a sustain discharge period PS to each of the common electrode groups.

Hereinafter, for the convenience of descriptions, high level periods of the driving signal will be denoted by S_{Y}, S_{Y1}, S_{Y2}, S_{X}, S_{X1} and S_{X2}, etc. Y represents a scanning electrode; Y₁ represents a scanning electrode belonging to a first group; and Y₂ represents a scanning electrode belonging to a second group. Similarly, X represents a common electrode; X₁ represents a common electrode belonging to a first group; and X₂ represents a common electrode belonging to a second group. It goes without saying that a falling transition period, a low level period and a rising transition period exist between the high level periods for each of the electrodes.

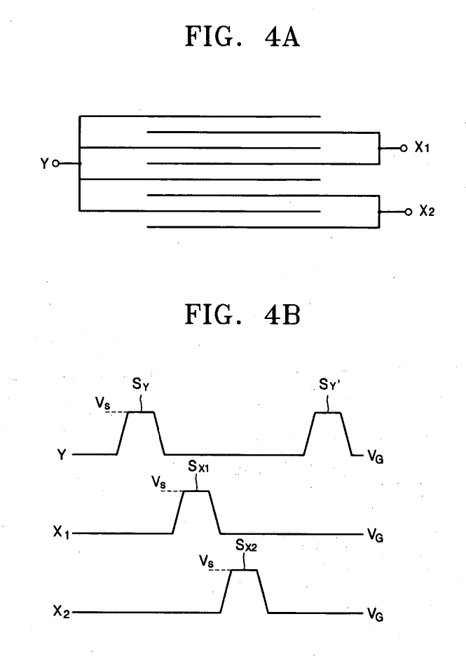

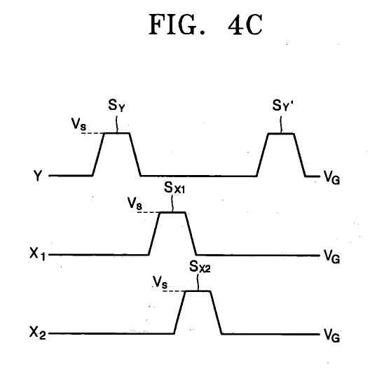

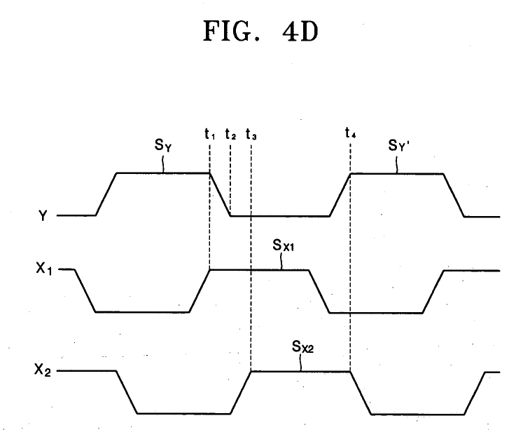

FIG. 4a schematically shows an embodiment of an electrode structure that permits efficientsustain discharge of the display panel.

Referring to FIG. 4a, in a sustain discharge period, a scanning electrode Y may be driven by a timing signal, and common electrodes may be grouped into a first group X₁ and a second group X₂ so that common electrodes of the first group X₁ and common electrodes of the second group X₂ may be driven individually by two different timing signals.

FIG. 4b is a timing diagram showing a period of a sustain discharge signal applied to the electrode structure shown in FIG. 4a, according to an embodiment of the present invention. That is, FIG. 4b shows a period of a sustain discharge signal applied alternately to the scanning electrode Y and the common electrodes X₁ and X₂ in the sustain discharge period. Address electrodes A₁ through Aₘ (not shown) may be maintained in a low level during the sustain discharge period, which will be the same in another embodiments to be described later. Between the high level sustain pulses S_{Y} and S_{Y}′ applied to the scanning electrode Y, sustain pulses S_{X1} and S_{X2} may be applied sequentially to the common electrode X₁ of the first group and the common electrode X2 of the second group, respectively. In other words, the sustain pulses may be applied sequentially in an order of S_{Y}->gap->S_{X1}->gap->S_{X2}->gap->S_{Y}′.

FIG. 4c is a timing diagram of a sustain discharge signal applied to the electrode structure shown in FIG. 4a, as a modified example of FIG. 4b, according to another embodiment of the present invention. Between the high level sustain pulses S_{Y} and S_{Y}′ applied to the scanning electrode Y, sustain pulses S_{X1} and S_{X2} may be applied sequentially to the common electrode X₁ of the first group and the common electrode X₂ of the second group, respectively. In other words, the sustain pulses may be applied sequentially in an order of S_{Y}->gap->S_{X1}>gap->S_{X2}->gap->S_{Y}′.

FIG. 4d is a timing diagram of a sustain discharge signal applied to the electrode structure shown in FIG. 4a, according to another embodiment of the present invention. Between the high level sustain pulses S_{Y} and S_{Y}′ applied to the scanning electrode Y, sustain pulses S_{X1} and S_{X2} may be applied sequentially to the common electrode X₁ of the first group and the common electrode X₂ of the second group, respectively. A period for sustain discharge shown in FIG. 4d will be described as follows.

When the scanning electrode Y is in a high level, a level of the common electrode X₁ of the first group may be changed at a time point t₁ to a high level. When the common electrode X₁ of the first group is in the high level, the level of the scanning electrode Y may be changed at a time point t₂ to a low level. When the scanning electrode Y is in the low level, the levels of common electrodes X₂ of second through final groups may be changed sequentially at a time point t3 to a high level. When the common electrode X₂ of the final group is in the high level, the level of the scanning electrode Y may be changed at a time point t₄ to a high level.

By applying the sustain discharge signals in such a manner, it is possible to maintain a duty rate of the sustain discharge signal near 50% while reducing a peak value of currents, thereby achieving stable sustain discharge.

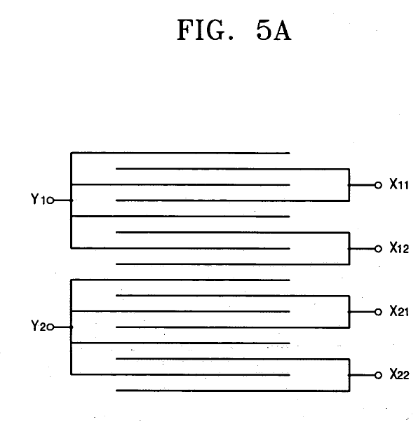

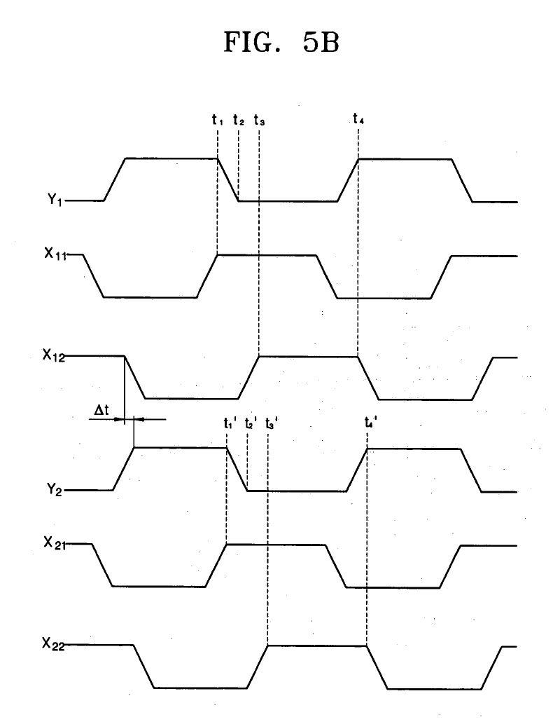

FIG. 5a schematically shows an electrode structure for sustain discharge of a display panel, as a modified example of the electrode structure shown in FIG. 4a, according to another embodiment of the present invention,

Referring to FIG. 5a, scanning electrodes may be grouped into two groups Y₁ and Y₂, which may be driven by two different sustain discharge signals. The respective scanning electrode groups Y₁ and Y₂ for sustain discharge may be sub-grouped in pairs with a plurality of common electrodes (X₁₁ and X₁₂) and (X₂₁ and X₂₂), respectively. Each of the groups Y₁ and Y2 has the same structure as the electrode structure of FIG. 4a and may be driven_in the same manner as described with reference to FIGS. 4b through 4d. Also, sustain discharge signals whose duty rates and timings may be different from one another may be applied to the electrodes of each of the groups.

FIG. 5b is a timing diagram of a sustain discharge signal applied to the electrode structure shown in FIG. 5a, according to an embodiment of the present invention. Pulses with a high level may be applied in a predetermined time interval Δt to each the scanning electrode groups Y₁ and Y₂. A period for sustain discharge in a group of Y₁, X₁₁ and X₁₂ shown in FIG. 5b will be described as follows.

When a sustain pulse with a high level is applied to the scanning electrode group Y₁, a level of a common electrode X₁₁ of a first group belonging to the scanning electrode group Y₁ may change at a time point t₁ to a high level. When the common electrode X₁₁ of the first group is in the high level, the level of the scanning electrode group Y₁ may change at a time point t2 into a low level. When the scanning electrode group Y₁ is in the low level, a level of a common electrode X₁₂ of a second group may be changed at a time point t₃ to a high level. When the common electrode X₁₂ of the second group is in the high level, the level of the scanning electrode group Y₁ may change at a time point t4 to a high level.

Sustain pulses with a high level may be applied in the predetermined time interval Δt to the scanning electrode groups Y₁ and Y₂. Accordingly, a second group of Y₂, X₂₁, and X₂₂ also operates in the same manner as in the first group of Y₁, X₁₁ and X₁₂.

Therefore, discharge currents generated in each of the groups may be temporally divided, which allows it to reduce a current peak of a driving circuit. Also, by appropriately adjusting the timings at which the pulses with the high level may be applied to the common electrodes (X₁₁, X₁₂) and (X₂₁, X₂₂) in each of the groups, it is possible to control a duty rate of a sustain discharge signal.

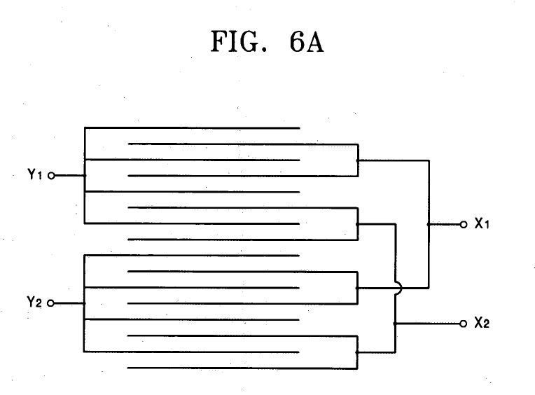

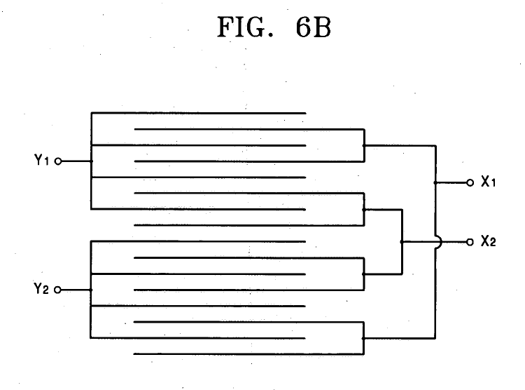

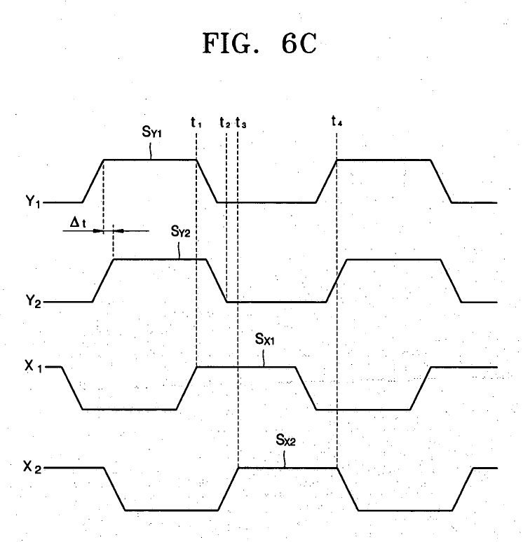

FIGS. 6a and 6b schematically show electrode structures for sustain discharge, as modified examples of the electrode structure shown in FIG. 5a, according to another embodiments of the present invention. FIG. 6c shows a timing diagram of a sustain discharge signal applied to common electrodes X₁ and X₂ with an intersected structure as shown in FIGS. 6a and 6b, according to an embodiment of the present invention. Referring to FIG. 6c, basically, sustain pulses (S_{Y1}, S_{X1}, S_{X2}) may be applied alternately to scanning electrode group Y₁ and common electrodes X₁ and X₂. Also, sustain pulses (S_{Y2}, S_{X1}, S_{X2}) may be applied alternately to scanning electrode group Y₂ and common electrodes X₁ and X₂. Sustain pulses S_{Y1} and S_{Y2} with a high level may be applied in a predetermined time interval Δt to the scanning electrode groups Y₁ and Y₂, in an order of S_{Y1}->S_{Y2}. A period for sustain discharge will be described as follows.

When a pulse of a high level is applied to all the scanning electrode groups Y₁ and Y₂, a level of a common electrode X₁ of a first group may be changed at a time point t₁ to a high level. When the common electrode X₁ of the first group is in the high level, the levels of the first scanning electrode group Y₁ through the final scanning electrode group Y₂ may be sequentially changed at a time point t₂ to a low level. When the final scanning electrode group Y₂ is in the low level, a level of a common electrode X₂ of the second group is changed at a time point t₃ to a high level. When the common electrode X₂ of the second group is in the high level, the level of the first scanning electrode group Y₁ may be changed at a time point t₄ to a high level. Therefore, discharge currents generated in each of the groups may be temporally divided, which allows it to reduce a current peak of a driving circuit. Sustain pulses with a high level may be applied in an order to S_{Y1}->S_{Y2}->S_{X1}->S_{X2}, within a period of a discharge sustain signal, which may be repeated.

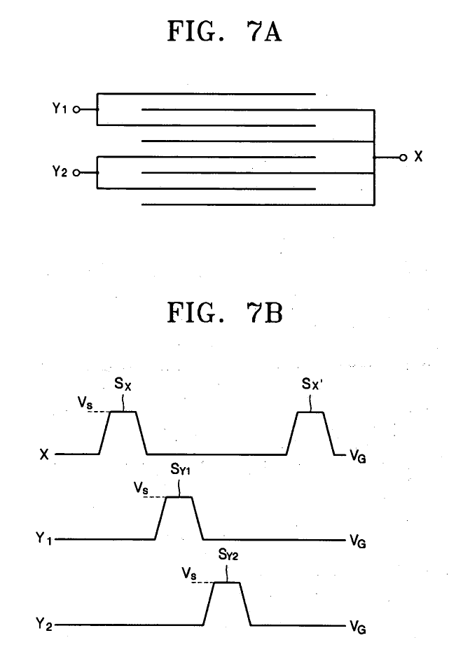

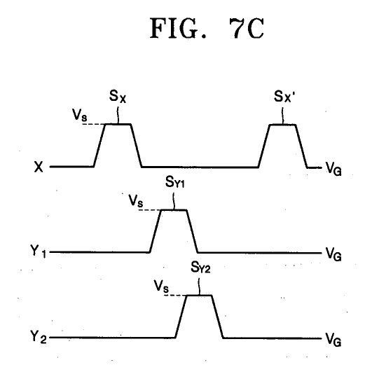

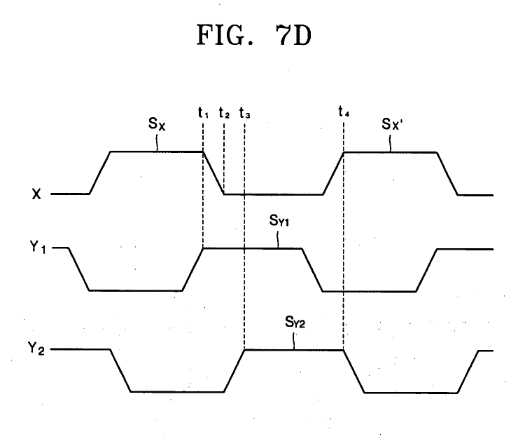

FIG. 7a schematically shows an electrode structure for sustain discharge, according to another embodiment of the present invention.

Referring to FIG. 7a, during a sustain discharge period, a common electrode X may be driven by a timing signal, and scanning electrodes may be grouped into a first group Y₁ and a second group Y₂, which may be driven by two different timing signals.

FIG. 7b is a timing diagram of a period of a sustain discharge signal applied to the electrode structure shown in FIG. 7a, according to an embodiment of the present invention. FIG. 7b shows a period of a sustain discharge signal applied alternately to a common electrode X and scanning electrodes Y_{1 and Y}₂ in a sustain discharge time period. Address electrodes A₁ through Aₘ (not shown) may be maintained in a low level during the sustain discharge period, which will be the same in another embodiments to be described later. Between high level sustain pulses S_{X} and S_{X}′ applied to the common electrode X, sustain pulses S_{Y1} and S_{Y2} may be applied sequentially to the first scanning electrode group Y₁ and the second scanning electrode group Y₂. In other words, sustain pulses may be applied sequentially in an order to S_{X}->gap->S_{Y1}->gap->S_{Y2}->gap->S_{X}′.

FIG. 7c is a timing diagram of a sustain discharge signal applied to the electrode structure shown in FIG. 7a, as a modified example of FIG. 7b, according to another embodiment of the present invention. Between the high level sustain pulses S_{X} and S_{X}′ applied to the common electrode X, sustain pulses S_{Y1} and S_{Y2} may be applied sequentially to the first scanning electrode group Y₁ and the second scanning electrode group Y₂. In other words, the sustain pulses may be applied in an order of S_{X}->gap->S_{Y1}->gap->S_{Y2}->gap->S_{X}′.

FIG. 7d is a timing diagram of a sustain discharge signal applied to the electrode structure shown in FIG. 7a, according to another embodiment of the present invention. Between the high level sustain pulses S_{X} and S_{X}′ applied to the common electrode X, sustain pulses S_{Y1} and S_{Y2} may be applied sequentially to the first scanning electrode group Y₁ and the second scanning electrode group Y₂. A period for sustain discharge shown in FIG. 7d will be described as follows.

When the common electrode X is in a high level, the first scanning electrode group Y₁ may be changed at a time point t₁ to a high level. When the first scanning electrode group Y₁ is in the high level, the level of the common electrode X may be changed at a time point t₂ to a low level. When the common electrode X is in the low level, levels of second through final scanning electrode groups Y₂ may be sequentially changed at a time point t₃ to a high level. When a final scanning electrode group Y₂ is in the high level, the level of the common electrode X may be changed at a time point t₄ to a high level.

By applying the sustain discharge signal in such a manner, it is possible to maintain a duty rate of a sustain discharge signal near 50% while reducing a current peak, thereby achieving stable sustain discharge.

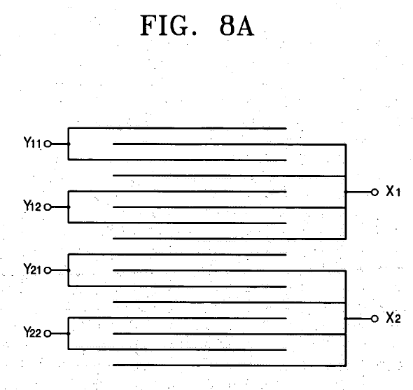

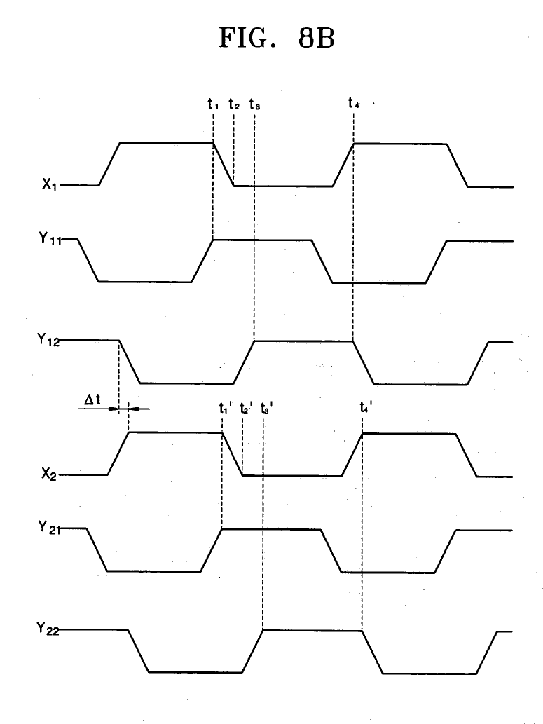

FIG. 8a schematically shows an electrode structure for sustain discharge, as a modified example of the electrode structure shown in FIG. 7a, according to another embodiment of the present invention,

Referring to FIG. 8a, two common electrode groups X₁ and X₂ may be driven by two different signals. The respective common electrode groups X₁ and X₂ may be sub-grouped in pairs with a plurality of scanning electrode groups (Y₁, Y₁₂) and (Y₂₁, Y₂₂), respectively. Each of the groups has the same structure as the electrode structure shown in FIG. 7a and may be forced to sustain discharge driving in the same manner as described with reference to FIGS. 7b through 7d. Sustain discharge signals whose duty rates and timings may be different from one another may be applied to each of the scanning electrode groups.

FIG. 8b is a timing diagram of a sustain discharge signal applied to the electrode structure shown in FIG. 8a, according to an embodiment of the present invention. Pulses with a high level may be applied in a predetermined time interval Δt to each of the common electrode groups X₁ and X₂. In a group of X₁, Y ₁, Y₁₂ shown in FIG. 8b, a period for sustain discharge will be described as follows.

When a high level pulse is applied to the common electrode group X₁, a level of a first scanning electrode group Y₁₁ belonging to the common electrode group X₁ may be changed at a time point t₁ to a high level. When the first scanning electrode group Y₁₁ is in the high level, the level of the common electrode group X₁ may be changed at a time point t₂ to a low level. When the common electrode group X₁ is in the low level, a level of a second scanning electrode group Y₁₂ may be changed at a time point t₃ to a high level. When the second scanning electrode group Y₁₂ is in the high level, a level of the common electrode group X₂ may be changed at a time point t₄ to a high level.

The pulses with the high level may be applied in the predetermined time interval Δt to the common electrode groups X₁ and X₂. Accordingly, a second group of X₂, Y₂₁, and Y₂₂ also operates in the same manner as in the first group of X₁, Y₁₁ and Y₁₂.

Therefore, discharge currents generated in each of the groups may be temporally divided, which allows it to reduce a current peak of a driving circuit. Also, by appropriately adjusting the timings at which the pulses with the high level may be applied to the scanning electrode groups (Y₁₁, Y₁₂) and (Y₂₁, Y₂₂) in each of the groups, it is possible to control a duty rate of a sustain discharge signal.

It will be appreciated by one of ordinary skill in the art that the electrode structure and driving signals shown in FIGS. 7a, 7b, 7c, and 7d may be reversed in the scanning electrodes and the common electrodes from the electrode structure and driving signals shown in FIGS. 4a, 4b, 4c, and 4d. Also, it will be appreciated by one of ordinary skill in the art that the electrode structure and driving signals shown in FIGS. 8a and 8b may be inverted in the scanning electrodes and the common electrodes from the electrode structure and driving signals shown in FIGS. 5a and 5b.

Likewise, as not shown in the drawings, the electrode structures shown in FIGS. 6a and 6b may be changed to reversed structures in the scanning electrode and the common electrode. Also, it is without saying that the timing signals shown in FIG. 6c may be applied to the reversed structures in the scanning electrode and the common electrode.

The present invention may be applied to all display devices which have an address period of selecting cells to be turned on in advance and a sustain period of emitting light in the selected cells. For example, by applying sustain pulses alternately to electrodes of forming cells, such as DC type PDPs, EL display devices, or LCDs as well as AC type PDPs, the present invention may be applied to image display devices.

The present invention may be embodied as a program stored on a computer readable medium that may be run on a general computer. Here, the computer readable medium includes but is not limited to storage media such as magnetic storage media (e.g., ROM's, floppy disks, hard disks, etc.), optically readable media (e.g., CD-ROMs, DVDs, etc.), and carrier waves (e.g., transmission over the Internet).

In particular, the panel driving method according to the present invention is made on a computer by a schematic or a VHDL (Very High speed integrated circuit Hardware Description Language). The panel diving method may be implemented by a programmable integrated circuit connected to the computer, for example, FPGA (Field Programmable Gate Array). The recording medium includes such a programmable integrated circuit.

As described above, the display panel and the panel driving method according to the present invention may obtain the following effects.

First, by adopting an electrode structure formed by a predetermined arrangement of one or more scanning electrode groups and one or more common electrode groups, it may be possible to group the common electrodes and scanning electrodes for sustain discharge into a predetermined number of groups and drive each of the groups individually, thereby allowing it to temporally divide discharge currents generated in each of the groups. Accordingly, it may be possible to lower a peak value of currents generated upon sustain discharge driving.

Second, it may be possible to maintain a duty rates of a sustain discharge signal applied sequentially to each of the common electrode groups and each of the scanning electrode groups, near maximum 50%, thereby achieving driving by a stable sustain signal.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method for driving a display panel to produce an efficient sustain discharge, the display panel including a plurality of scanning electrodes and a plurality of common electrode groups paired with the plurality of scanning electrodes, the method comprising the steps of:
driving the plurality of scanning electrodes by a sustain discharge signal;
individually driving the plurality of common electrode groups by different sustain discharge signals
alternately applying high level sustain pulses to each of the plurality of scanning electrodes and each of the plurality of common electrode groups to provide an efficient sustain discharge, and
sequentially applying high level sustain pulses to each of the plurality of common electrode groups in time intervals between the high level sustain pulses applied to the plurality of scanning electrodes.

2. The method of claim 1, wherein a period for sustain discharge comprises:
changing a level of a first common electrode group to a high level when the plurality of scanning electrodes are in a high level;
changing levels of the plurality of scanning electrodes to a low level when the first common electrode group is in the high level;
changing levels of second through final common electrode groups sequentially to a high level when the plurality of scanning electrodes are in the low level; and
changing levels of the plurality of scanning electrodes to a high level when the final common electrode group is in the high level.

3. A method for driving a display panel to produce an efficient sustain discharge, the display panel including a plurality of scanning electrode groups and a plurality of common electrode groups paired with the plurality of scanning electrode groups, the method comprising the steps of:
individually driving the plurality of scanning electrode groups by different sustain discharge signals;
individually driving the plurality of common electrode groups by different sustain discharge signals;
alternately applying high level sustain pulses to each of the plurality of scanning electrode groups and each of the plurality of common electrode groups paired with the plurality of scanning electrode groups to provide an efficient sustain discharge, and
sequentially applying high level sustain pulses to each of the plurality of common electrode groups paired with the plurality of scanning electrode groups in time intervals between the high level sustain pulses applied to each of the plurality of scanning electrode groups.

4. The method of claim 3, wherein pulses with a high level are applied in a predetermined time interval to each of the plurality of scanning electrode groups, and for each of the plurality of scanning electrode groups, a period for sustain discharge comprises:
changing a level of a first common electrode group belonging to a corresponding scanning electrode group to a high level, when a high level pulse is applied to each of the plurality of scanning electrode groups;
changing levels of the plurality of scanning electrode groups to a low level when the first common electrode group is in the high level;
changing levels of second through final common electrode groups sequentially to a high level when the plurality of scanning electrode groups are in the low level; and
changing levels of the plurality of scanning electrode groups to a high level when the final common electrode group is in the high level.

5. The method of claim 3, wherein a period for sustain discharge comprises:
changing a level of a first common electrode group to a high level when a pulse with a high level is applied to all the plurality of scanning electrode groups;
changing levels of a first through final scanning electrode groups sequentially to a low level when the first common electrode group is in the high level;
changing levels of a second through the final common electrode groups sequentially to a high level when the final scanning electrode group is in the low level; and
changing levels of the first through the final scanning electrode groups sequentially to a high level when the final common electrode group is in the high level.

6. A method for driving a display panel to produce an efficient sustain discharge, the panel including a plurality of common electrodes and a plurality of scanning electrode groups paired with the plurality of common electrodes, the method comprising the steps of:
driving the plurality of common electrodes by a sustain discharge signal;
individually driving the plurality of scanning electrode groups by different sustain discharge signals;
alternately applying high level sustain pulses to each of the plurality of common electrodes and each of the plurality of scanning electrode groups to provide an efficient sustain discharge, and
sequentially applying high level sustain pulses to each of the plurality of scanning electrode groups in time intervals between the high level sustain pulses applied to the plurality of common electrodes.

7. The method of claim 6, wherein a period for sustain discharge comprises:
changing a level of a first scanning electrode group to a high level when the plurality of common electrodes are in a high level;
changing levels of the plurality of common electrodes to a low level when the first scanning electrode group is in the high level;
changing levels of second through final scanning electrode groups sequentially to a high level when the plurality of common electrodes are in the low level; and
changing levels of the plurality of common electrodes to a high level when the final scanning electrode group is in the high level.

8. A method for driving a display panel to produce an efficient sustain discharge, the panel including a plurality of common electrode groups and a plurality of scanning electrode groups paired with the plurality of common electrode groups, the method comprising the steps of:
individually driving the plurality of common electrode groups by different sustain discharge signals;
individually driving the plurality of scanning electrode groups by different sustain discharge signals;
alternately applying high level sustain pulses to the plurality of common electrode groups and the plurality of scanning electrode groups paired with the plurality of common electrode groups to provide an efficient sustain discharge; and
sequentially applying high level sustain pulses to each of the plurality of scanning electrode groups paired with the plurality of common electrode groups, in time intervals between the high level sustain pulses applied to the plurality of common electrode groups.

9. The method of claim 8, wherein high level pulses are applied in a predetermined time interval to each of the plurality of common electrode groups, and in each of the plurality of common electrode groups, a period for sustain discharge comprises:
changing a level of a first scanning electrode group belonging to a corresponding common electrode group to a high level, when a pulse with a high level is applied to each of the plurality of common electrode groups;
changing levels of the plurality of common electrode groups to a low level when the first scanning electrode group is in the high level;
changing levels of second through final scanning electrode groups sequentially to a high level when the plurality of common electrode groups are in the low level; and
changing a voltage applied to the plurality of common electrode groups to a high level when the final scanning electrode group is in the high level.

10. The method of claim 8, wherein a period for sustain discharge comprises:
changing a level of a first scanning electrode group to a high level when all the plurality of common electrode groups are in a high level;
changing levels of a first through final common electrode groups sequentially to a low level when the first scanning electrode group is in the high level;
changing levels of a second through the final scanning electrode groups sequentially to a high level when the final common electrode group is in the low level; and
changing the first through the final common electrode groups sequentially to a high level when the final scanning electrode group is in the high level.

11. A display panel with an electrode structure, comprising:
a plurality of scanning electrodes to be driven by a sustain discharge signal; and
a plurality of common electrode groups which are paired with the plurality of scanning electrodes and driven individually by different sustain discharge signals.

12. A display panel with an electrode structure, comprising:
a plurality of scanning electrode groups, which are driven individually by first different sustain discharge signals; and
a plurality of common electrode groups, which are paired with the plurality of scanning electrode groups and driven individually by second different sustain discharge signals.

13. A display panel with an electrode structure, comprising:
a plurality of common electrodes, which are driven by a sustain discharge signal; and
a plurality of scanning electrode groups, which are paired with the plurality of common electrodes and driven individually by different sustain discharge signals.

14. A display panel with an electrode structure, comprising:
a plurality of common electrode groups, which are driven individually by first different sustain discharge signals; and
a plurality of scanning electrode groups, which are paired with the plurality of common electrode groups and driven individually by second different sustain discharge signals.

15. A computer-readable medium having embodied thereon a computer program for executing the method of claim 1.

16. A computer-readable medium having embodied thereon a computer program for executing the method comprising:
changing a level of a first common electrode group to a high level when the plurality of scanning electrodes are in a high level;
changing levels of the plurality of scanning electrodes to a low level when the first common electrode group is in the high level;
changing levels of second through final common electrode groups sequentially to a high level when the plurality of scanning electrodes are in the low level; and
changing levels of the plurality of scanning electrodes to a high level when the final common electrode group is in the high level

17. A computer-readable medium having embodied thereon a computer program for executing the method comprising:
individually driving the plurality of scanning electrode groups by different sustain discharge signals;
individually driving the plurality of common electrode groups by different sustain discharge signals;
alternately applying high level sustain pulses to each of the plurality of scanning electrode groups and each of the plurality of common electrode groups paired with the plurality of scanning electrode groups to provide an efficient sustain discharge, and
sequentially applying high level sustain pulses to each of the plurality of common electrode groups paired with the plurality of scanning electrode groups in time intervals between the high level sustain pulses applied to each of the plurality of scanning electrode groups.

18. A computer-readable medium having embodied thereon a computer program for executing the method comprising:
changing a level of a first common electrode group belonging to a corresponding scanning electrode group to a high level, when a high level pulse is applied to each of the plurality of scanning electrode groups;
changing levels of the plurality of scanning electrode groups to a low level when the first common electrode group is in the high level;
changing levels of second through final common electrode groups sequentially to a high level when the plurality of scanning electrode groups are in the low level; and
changing levels of the plurality of scanning electrode groups to a high level when the final common electrode group is in the high level.

19. A computer-readable medium having embodied thereon a computer program for executing the method comprising:
changing a level of a first common electrode group to a high level when a pulse with a high level is applied to all the plurality of scanning electrode groups;
changing levels of a first through final scanning electrode groups sequentially to a low level when the first common electrode group is in the high level;
changing levels of a second through the final common electrode groups sequentially to a high level when the final scanning electrode group is in the low level; and
changing levels of the first through the final scanning electrode groups sequentially to a high level when the final common electrode group is in the high level.
